(19) United States
(12) Patent Application Publication
(10) Pub. No.: US 2026/0072518 A1
(43) Pub. Date: Mar. 12, 2026

(54) AUTOMATED ASSISTANT THAT ADAPTS TO BE RESPONSIVE TO SIGN LANGUAGE COMMANDS UNFAMILIAR TO THE AUTOMATED ASSISTANT

(71) Applicant: GOOGLE LLC, Mountain View, CA (US)

(72) Inventors: Garrett Tanzer, Boston, MA (US); Sepehr Sam Sepah, Pleasanton, CA (US)

(21) Appl. No.: 18/830,016

(22) Filed: Sep. 10, 2024

(51) Int. Cl. G06F 3/01; G06F 3/04883; G06F 9/451; G06V 40/20

(52) U.S. Cl. CPC G06F 3/017; G06F 3/04883; G06F 9/453; G06V 40/28

(57) ABSTRACT

Implementations set forth herein relate to an automated assistant that can adapt to be responsive to sign language commands, or other inaudible gestures, that may initially be unfamiliar to the automated assistant. The automated assistant can initially determine that a particular sign language command is unfamiliar based on initial processing that indicates the available stored translations do not correspond to the particular sign language command. In response, the automated assistant can request that a user provide a translation for the particular sign language command using one or more interfaces of a computing device. For example, the user can type the translation into a keyboard or other touch interface, or sign the translation through an image sensor interface such as a camera (e.g., via fingerspelling). Training data can be generated based on this additional input, thereby allowing the automated assistant to adapt to a growing lexicon of sign language commands.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

Some automated assistants can be responsive to sign language commands or other gesture-based commands, thereby allowing users to benefit from certain functionality of automated assistants without limiting these users to text-based interactions with these automated assistants, such as users with hearing impairments, users with speech impairments, and/or other users. Persons that frequently rely on sign language commands or gesture-based commands may develop certain preferred gestures to refer to a person, place, concept, and/or thing. However, when an uncommon gesture is utilized to interact with an automated assistant, the automated assistant may not be able to readily interpret the uncommon gesture. As a result, the automated assistant may not fulfill the corresponding request from the user, or otherwise, may not accurately respond to the user. When this happens frequently across a population of users, significant amounts of power and computational bandwidth can be wasted. This unrecognized problem with automated assistants may be exacerbated by the further adoption of automated assistants across the globe and in areas where further uncommon names and labels may be necessary.

### SUMMARY

Implementations set forth herein relate to an automated assistant application or other application that can be customized to recognize particular sign language commands for referring to proper names and/or other uncommon sign language gestures. Customization of the automated assistant application can be performed using training data that is, for example, generated based on a response of a user to a prompt rendered via a device interface, generated based on a response of a user provided via a device interface and while the automated assistant is in a mode that enables the user to define the particular sign language commands, etc. In some implementations, the prompt can solicit the user to characterize a sign language command that has not been recognized. Further, the interface can be provided by the automated assistant in certain contexts, such as when a sign language gesture is detected by the automated assistant, but the automated assistant determines that there is a lack of stored sign data associated with the unrecognized sign language gesture. In other implementations, the user can explicitly enter the mode in which the user can define the particular sign language commands.

For example, the user can invoke the automated assistant or other application using a sign language gesture or other invocation command. During the interaction, the user can provide a particular sign language gesture that refers to a friend of the user (e.g., “Simone”). This particular sign language gesture may not be known to anyone else except the user's community, or otherwise may be uncommon to some other communities of sign language users. In response to receiving a series of sign language gestures that include the particular sign language gesture, the automated assistant can process input data characterizing the series of sign language gestures. The input data can be processed using one or more heuristic processes and/or one or more machine learning techniques. When the automated assistant determines that the portion of the input data corresponding to the particular sign language gesture does not have any stored correlation to other natural language data, the automated assistant can render an indication at an interface.

For example, the user can be performing the series of sign language gestures in front of a camera of a computing device that provides access to the automated assistant application, and the indication can be rendered at a graphical user interface (GUI) of the computing device. The indication can be, for example, one or more characters or symbols set forth as placeholders within a rendered translation of the series of sign language gestures. In some instances, when the user is asking the automated assistant application to place a phone call to their friend, a translation of this command can be rendered at the GUI and the placeholder character can be arranged where the name of the friend would otherwise be if the automated assistant application recognized the particular sign language gesture.

In response to the indication being rendered, the user can provide an input to the automated assistant application or other application to indicate a willingness of the user to clarify the meaning of the particular sign language gesture. For example, the user can perform a subsequent sign language gesture that lets the automated assistant know that the user would like to spell out the name of the friend, so that the spelled name (e.g., “Simone”) can be stored in correlation to the particular sign language gesture. Alternatively, or additionally, the user can provide a touch input or other input to an interface of the computing device, or other device, to indicate that the user can specify the meaning of the particular sign language gesture.

In response to receiving this input or other acknowledgment from the user, the automated assistant can process a subsequent input that specifies the meaning of the particular sign language gesture. In some instances, this subsequent input can be additional sign language gestures that specify individual characters that spell a word or multiple words that should be stored as the meaning for the particular sign language gesture. Notably, the subsequent sign language gesture can include more signs (e.g., fingerspelling of “Simone” by signing “s”, “i”, “m”, “o”, “n”, “e”) relative to the particular sign language gesture (e.g., a name sign or single gesture corresponding to “Simone”). While the user could provide the subsequent sign language gesture each time he/she wishes to refer to the name of the friend in this example, doing so is computationally wasteful since six sign language signs need to be processed and interpreted (e.g., one for each of “s”, “i”, “m”, “o”, “n”, “e”) compared to a single sign for the particular sign language gesture (e.g., one for “Simone”). Alternatively, or additionally, the subsequent input can be a typed input that spells out the word or words that should be stored in association with the particular sign language gesture data (e.g., type out “Simone”). Alternatively, or additionally, the input data can be any other input that can be processed by a computing device for indicating the meaning of a gesture performed by one or more users.

In response to receiving this subsequent input from the user, training data can optionally be generated for further training one or more machine learning models to recognize subsequent sign language gestures from the user. For example, positive and negative training data instances can be identified and/or generated based on the data received from the user, with prior permission from the user. For instance, certain available data, which characterizes one or more other users performing that particular sign language gesture that means something different can be utilized to generate negative training instances. Alternatively, or additionally, other available data characterizing one or more other users performing the particular sign language gesture to mean the same thing that the user intended the particular sign language gesture to mean can be utilized to generate positive training instances.

Although the above example is described with respect to particular sign language gesture referring to a friend of the user in sign language (e.g., a name sign for “Simone”) and the subsequent input defining the particular sign language gesture, it should be understood that is for the sake of example and is not meant to be limiting. For instance, assume that the user is ordering coffee via an automated assistant and provides a particular sign language gesture referring to a name of a coffee in sign language (e.g., corresponding to “venti” or the like) and the name of the coffee is not defined. In this example, and rather than alerting the user that the coffee cannot be completed, the automated assistant can prompt the user to define the particular sign language gesture and continue with ordering the coffee as requested by the user.

In some implementations, generative AI can be utilized to generate training data that includes images and/or video of one or more persons performing the particular sign language gesture in various contexts. This training data can then be utilized to train one or more models for processing subsequent sign language gestures provided by the user. In this way, the automated assistant and/or other application that relies on these one or more machine learning models can more readily and/or more accurately respond to the particular sign language gesture. In some implementations, the one or more machine learning models can also be trained on contextual data, thereby allowing biasing to occur for certain contexts. Said another way, depending on a subsequent context in which the user performs the particular sign language gesture, processing of input data can be biased towards a user-specified meaning for the particular sign language gesture, or biased away from the user-specified meaning for the particular sign language gesture.

For example, contextual data for a particular sign language gesture can indicate that the user typically provides the particular sign language gesture to mean the user-specified meaning when invoking the automated assistant to perform a specific type of operation. For instance, the specific type of operation can involve specifying a name for a person, such as when placing a phone call or sending a text message. However, the contextual data can also indicate that the user also performs the particular sign language gesture to mean something else when asking the automated assistant to perform a different type of operation (e.g., searching for recipes). As a result, processing of input data corresponding to the particular sign language gesture can be biased according to each of these contexts. Said another way, certain candidate translations for the particular sign language gesture can be identified (or biased towards or away from) in response to detecting the particular sign language gesture and based on the specific type of operation. However, the automated assistant may only respond according to the candidate translation that is associated with a more prioritized score or weight relative to other candidate translations.

The above description is provided as an overview of some implementations of the present disclosure. Further description of those implementations, and other implementations, are described in more detail below.

### BRIEF DESCRIPTION OF THE DRAWINGS

FIG. 1A, FIG. 1B, FIG. 1C, FIG. 1D, FIG. 1E, and FIG. 1F illustrate views of a user interacting with an automated assistant using sign language and causing the automated assistant to adapt to be responsive to uncommon sign language gestures.

FIG. 2 illustrates a system that provides access to an automated assistant or other application that can receive sign language and/or other inaudible communications and adapt to be responsive to uncommonly used sign language commands.

FIG. 3 illustrates a method for operating an automated assistant that facilitates interactions through sign language commands and/or inaudible gestures, and adapts to be more accurately responsive to uncommon or unfamiliar inaudible gestures.

FIG. 4 is a block diagram of an example computer system.

### DETAILED DESCRIPTION

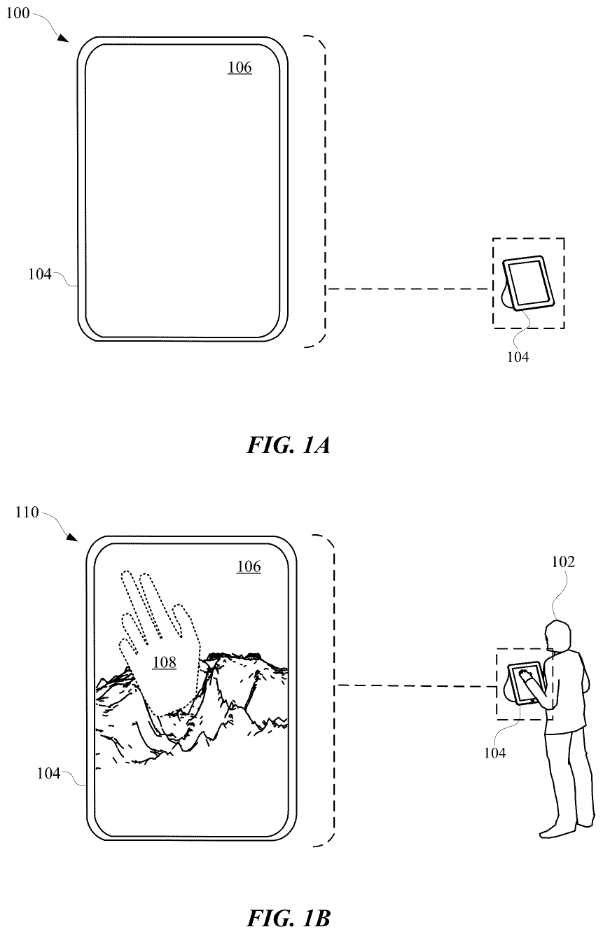

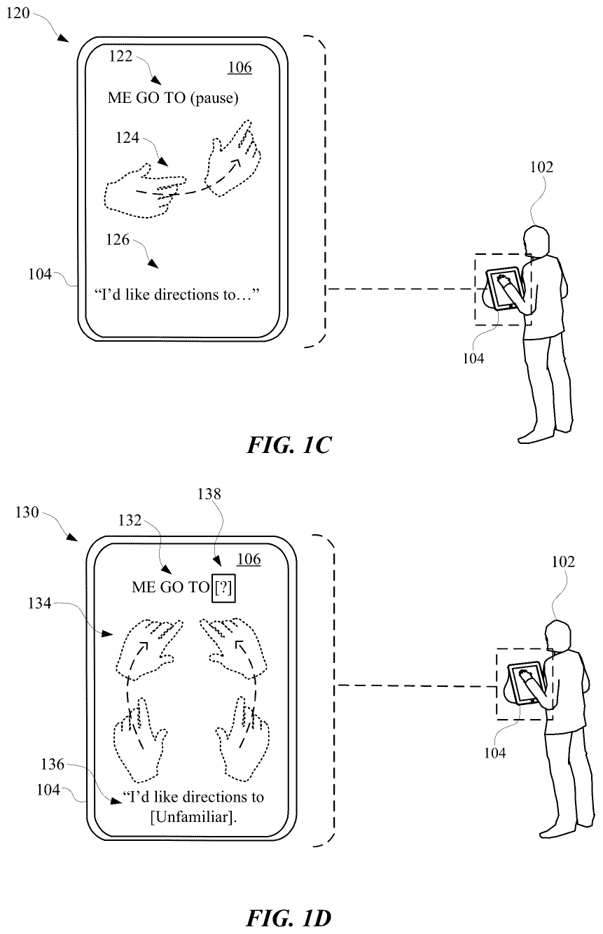

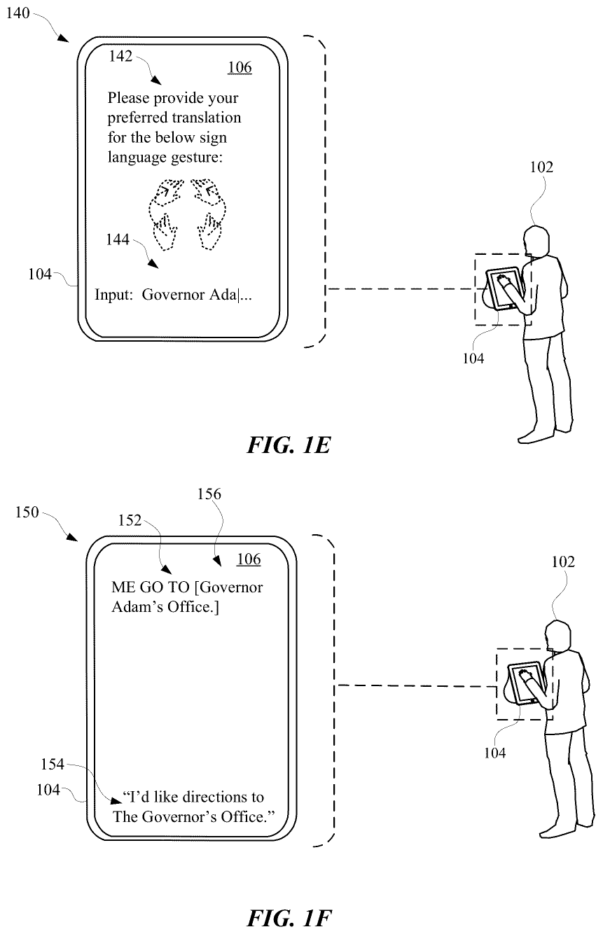

FIG. 1A, FIG. 1B, FIG. 1C, FIG. 1D, FIG. 1E, and FIG. 1F illustrate views of a user interacting with an automated assistant using sign language and causing the automated assistant to adapt to be responsive to uncommon sign language gestures or other gesture-based commands. FIG. 1A illustrates a view of a computing device 104 that can include an automated assistant and/or other application that is responsive to sign language gestures and/or other gesture-based commands directed to the computing device 104 or another device. The computing device 104 can be a standalone display device or other type of computing device that can provide access to an automated assistant. Initially, and as illustrated in view 100 of FIG. 1A, the computing device 104 can be in a standby mode, low power (e.g., lower power consumption, reduced sampling rate for one or more sensors, etc.), and/or otherwise be idle when a user is not present at or near the computing device 104. For example, and with prior permission from the user 102, the automated assistant and/or other application can determine a presence of the user 102 using sensor data generated at one or more sensors associated with the computing device 104. The sensor data can include image data, proximity data, temperature data, audio data, and/or any other type of data that can be generated using one or more sensors. In some implementations, the sensor data can include image data (or other vision data, including video data, that is collectively referred to herein as “image data”), and the image data can be processed to determine a gaze of the user 102 and, in response to determining that the user 102 is directing their gaze at the computing device 104, the automated assistant can initialize one or more operations. For example, the one or more operations can include determining whether the user 102 is intending to interact with the automated assistant via sign language and/or other non-verbal commands (e.g., gesture-based commands). In some implementations, the automated assistant can optionally be responsive to detecting a presence of the user 102 and/or detecting one or more hands or other appendages of the user 102. As a result, the one or more operations can be initialized for preparing the automated assistant to be responsive to a sign language command from the user 102.

Alternatively, or additionally, the automated assistant can detect a presence of one or more hands of the user 102, with prior permission from the user 102, and cause a display interface 106 of the computing device 104 to render a real-time depiction 108 of one or more hands of the user 102 (e.g., a real-time depiction of an animation, avatar, moving outline, etc. corresponding to an arrangement of the user's hand(s)). Alternatively, or additionally, the automated assistant can detect a presence of one or more hands of the user 102, with prior permission from the user 102, and cause the display interface 106 of the computing device 104 to render a generic depiction of one or more hands (e.g., a real-time depiction of an arrangement of the user's hand(s)). In some implementations, and as illustrated in view 110 of FIG. 1B, the depiction 108 can be a reduced, or enhanced, rendered depiction of one or more hands of the user 102, and can be updated dynamically as the user 102 moves their hands. In this way, the automated assistant can indicate to the user 102 that the automated assistant is already responding to hand movements of the user 102, and therefore is prepared to respond to a forthcoming sign language command and/or other gesture-based command.

The user 102 can begin providing an automated assistant request with, or without, providing a non-verbal invocation command (e.g., corresponding to “Assistant...”or the like). For example, and as illustrated in view 120 of FIG. 1C, the user 102 can provide the beginning of a sign language command, such as a command requesting directions. In response to the user 102 providing the sign language command, the automated assistant can determine, for instance, an American Sign Language (ASL) Gloss representation for the command and/or a non-Gloss textual representation of the sign language command. For example, and as illustrated in view 120 of FIG. 1C, the automated assistant can cause the display interface 106 to render the ASL Gloss 122 “ME GO TO (pause)” in response to the user 102 providing the sign language command. Alternatively, or additionally, the automated assistant can cause the display interface 106 to render one or more hand symbols 124 that represent a particular sign language command the user 102 is currently providing, has already provided, and/or is expected to provide.

Alternatively, or additionally, the automated assistant can cause the display interface 106 to render a textual representation 126 of the sign language command the user 102 is currently providing, has already provided, and/or is expected to provide. In this way, the user 102 can receive feedback regarding whether the automated assistant is accurately interpreting the sign language command being provided by the user 102. This can preserve computational resources that might otherwise be consumed when an automated assistant is interpreting a user input incorrectly, initializes an incorrect action, and/or otherwise causes a user to repeat their input for re-processing.

In some implementations, the user 102 may use a particular sign language gesture to refer to a name or other label for a person, place, concept or thing. This particular sign language gesture can be unfamiliar to the automated assistant and, in response, the automated assistant can cause an indication of the unfamiliar gesture to be rendered at the display interface 106 or other interface. For example, the indication can be a placeholder GUI element (e.g., a question mark or other graphic) rendered at or near a translation of the series of sign language commands being provided by the user 102 (e.g., as indicated at 136 and/or 138 in view 130 of FIG. 1D). In some implementations, the ASL Gloss 132 can be updated to include the indication and/or the textual representation 126 can be updated to include the indication as indicated at 138 and/or a different indication (e.g., “[Unfamiliar]”) as indicated at 136. In some implementations, the automated assistant can cause the display interface 106 to render one or more other hand symbols 134 that represent the particular sign language gesture that was unfamiliar. For example, the user 102 may have performed a sign language gesture using both of their hands to refer to a location in an uncommon way. Sensor data captured when the user is providing the sign language gesture can be processed to provide the other hand symbols 134 and/or other description of the sign language gesture. In this way, the user 102 can be put on notice of the sign language gesture that the automated assistant may not be familiar with.

In some implementations, determining whether the automated assistant is unfamiliar with the particular sign language gesture can involve processing input data using one or more heuristic processes and/or one or more trained machine learning models. For example, a score or metric can be assigned to a potential translation for the particular sign language gesture. When the score and/or metric does not satisfy a threshold, the particular sign language gesture can be designated as unfamiliar. In some implementations, this score and/or metric can be generated by mapping an embedding for the particular sign language gesture in a latent embedding space. In such implementations, the score and/or metric can be based on the distance between embeddings in the latent space, wherein at least one embedding corresponds to an estimated translation for the particular sign language command that is unfamiliar.

When the automated assistant determines that there is no stored translation for the particular sign language command, such as when a score and/or metric does not satisfy a threshold, the indication of the unfamiliar sign language command can be rendered for the user 102. In some implementations, the user 102 can proactively provide additional input to expressly define the particular sign language command. Alternatively, or additionally, the automated assistant can render a suggestion 142 for the user 102 to define the particular sign language gesture, as shown in view 140 of FIG. 1E. For example, the automated assistant can request that the user 102 to describe a definition for the particular sign language gesture using other sign language gestures and/or providing another input to an interface of the computing device 104, or another device. In some implementations, the automated assistant can provide an interface for typing an input 144 that corresponds to a translation for the particular sign language gesture. Alternatively, or additionally, the automated assistant can initialize a camera or other sensor for capturing an inaudible or audible input from the user 102 for describing the particular sign language gesture (e.g., via fingerspelling). In response, the user 102 can provide the input 144, such as a typed input for the name of a location (e.g., “Governor Adam's Office”).

In response to receiving this input 144, the automated assistant can perform the operation that the user 102 initially invoked the automated assistant to perform (e.g., requesting directions to Governor Adam's Office). The automated assistant can also indicate a complete ASL Gloss 152 with a translation 156 for the unfamiliar sign language gesture, and/or a textual translation 154 with the translation filled in, as shown in view 150 of FIG. 1F. Alternatively, or additionally, the automated assistant can generate training data based on the input 144 from the user 144 and any data associated with the unfamiliar sign language gesture. In this way, one or more trained machine learning models can be updated such that subsequent inputs can be more accurately responded to by the automated assistant. This can reduce wasting of computational resources, which may otherwise be consumed repeatedly attempting to process unfamiliar sign language commands when the automated assistant has no functionality for adapting to such unfamiliar sign language gestures and/or other gesture-based commands.

In some implementations, the training data can include positive training instances and/or negative training instances. For example, the training data can include a positive training instance that is based on data generated during the interactions described for FIGS. 1A-1F, and with prior express permission from the user 102. In some implementations, the training data can include positive training instances and/or negative training instances that are generated using a generative AI model. For example, an AI-generated entity can be the subject of one or more images and/or of a video wherein the unfamiliar sign language gesture is performed to correctly indicate the translation provided by the user, and the corresponding images and/or video can then be shared with other users. In some implementations, the automated assistant can determine to share the demonstration with other users estimated to use the unfamiliar sign language command, and/or with other users that are estimated to refer to the translation. This sharing of images and/or video demonstrations can be based on prior interactions between the other users and their respected instances of the automated assistant. Additionally, these determinations can be performed with prior express permission from the user and the other users.

As described herein, the generative AI model can be any sequence-to-sequence based machine learning model capable of generating generative vision data, generative audio data, generative textual data, and/or other forms of generative data. Some non-limiting examples of these sequence-to-sequence based machine learning models capable that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other sequence-to-sequence generative models or families of sequence-to-sequence generative models.

In some implementations, the positive and/or negative training data instances can be based on content available to the automated assistant, wherein the content shows the translation being referenced and/or the particular sign language command being utilized. When the particular sign language command is being utilized to refer to something other than the translation preferred by the user, this content can be utilized to generate positive and/or negative training data instances. Alternatively, or additionally, when the translation is being referred to using a different sign language gesture than the particular sign language gesture performed by the user 102, this content can also be utilized to generate positive and/or negative training instances. In some implementations, this content can be publicly available via a public website or public application, and/or can be video content, image content, audio content, textual content, computer-readable content, and/or any other content that can be communicated.

For example, the positive training data instances can be generated by providing the generative AI model with an indication of the particular sign language command and an indication of different types of operations associated with the particular sign language command. The generative AI model can then process the indication of the particular sign language command and the indication of different types of operations associated with the particular sign language command to generate the positive training data instances. For instance, assume the particular sign language command is a name sign for a contact entry of the user. In this instance, the different types of operations associated with the particular sign language command can include different communication techniques associated with the contact entry of the user. Accordingly, a first positive training data instance can include a person performing one or more sign language commands corresponding to “call [contact entry]”, a second positive training data instance can include a person performing one or more sign language commands corresponding to “text [contact entry]”, a third positive training data instance can include a person performing one or more sign language commands corresponding to “email [contact entry]”, and so on.

Further, the negative training data instances can be generated by providing the generative AI model with an indication of a different sign language command and an indication of different types of operations associated with the particular sign language command. The generative AI model can then process the indication of the different sign language command and the indication of different types of operations associated with the particular sign language command to generate the positive training data instances. For instance, assume the different sign language command is a generic sign language sign that is not associated with any contact entry of the user. In this instance, the different types of operations associated with the particular sign language command can include different communication techniques. Accordingly, a first negative training data instance can include a person performing one or more sign language commands corresponding to “call [different sign language command]”, a second negative training data instance can include a person performing one or more sign language commands corresponding to “text [different sign language command]”, a third negative training data instance can include a person performing one or more sign language commands corresponding to “email [different sign language command]”, and so on. By using the positive training instances, the automated assistant can subsequently determine when one or more sign language commands include the particular sign language command, and by using the negative training instances, the automated assistant can subsequently determine when one or more sign language commands include an undefined sign language command that may result in prompting the user to define the undefined sign language command.

In some implementations, processing of sign language commands can be biased according to a type of operation that the automated assistant or other application is being requested to perform. For example, when sign language gestures are being processed by the automated assistant, the automated assistant can determine a type of operation that is being requested by the user performing the sign language gestures. These types of operations can include any category of operation capable of being performed or otherwise facilitated by the automated assistant application and/or another application, either directly or indirectly. For example, a type of operation can include placing a phone call, sending a text message, controlling a device, asking for directions, requesting information on a topic, requesting to control another application, and/or any other type of operation that can be performed by an application.

Based on determining the type of operation, processing of a particular portion of a sign language gesture or other gesture (e.g., a portion considered to be unfamiliar) can be biased. For example, an unfamiliar sign language gesture that seems to refer to a proper name can be biased so that the proper name is selected as the translation in certain circumstances. Alternatively, or additionally, when an unfamiliar sign language gesture is estimated to refer to a location rather than a proper name, but the type of operation includes identifying a contact to send a message to, the process of determining the translation can be biased to refer to the proper name rather than the location. In this way, the process of requesting the user to expressly provide the translation for an unfamiliar sign language gesture in every context or circumstance can be avoided.

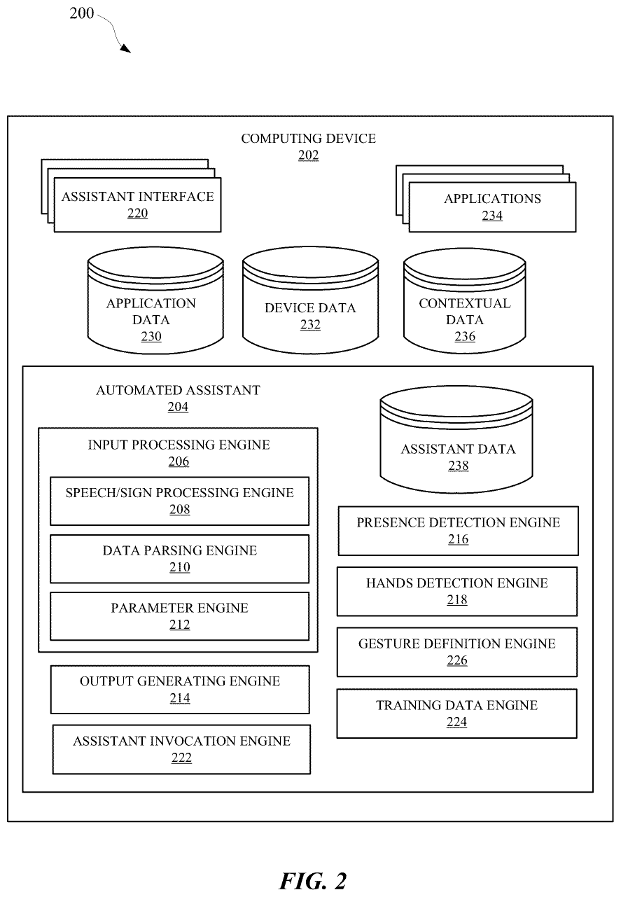

FIG. 2 illustrates a system 200 that facilitates an automated assistant or other application that can receive sign language and/or other inaudible communications and adapt to be responsive to unfamiliar sign language commands and/or other gestures. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal input, a non-verbal input, a sign language command (or other gesture-based commands), a textual input, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204.

The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user and/or non-spoken but audible inputs from the user (e.g., haptic, touch, etc.). In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi® network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system) - or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech/sign processing engine 208, which can process audio data and/or image data received at an assistant interface 220 to identify any text to be interpreted from an input (e.g., a sign language gesture). The input data can be transmitted from, for example, the computing device 202 to the server device in order to preserve computational resources at the computing device 202. Additionally, or alternatively, the input data can be exclusively processed at the computing device 202.

The process for converting the audio or image data to text can include a speech or image recognition algorithm, which can employ neural networks and/or statistical models for identifying groups or portions of input data corresponding to words or phrases. The text converted from the audio data or derived from the image data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user (e.g., graphical feedback, selectable suggestions, etc.), and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device object recognition, on-device sign language recognition, on-device natural language understanding, and on-device fulfillment. For example, on-device image recognition can be performed using an on-device image recognition module that processes image data (detected by the camera(s)) using an end-to-end image recognition machine learning model stored locally at the computing device 202. The on-device image recognition generates recognized text for a sign language command (if any) present in the image data. Also, for example, on-device natural language understanding (NLU) can be performed using an on-device NLU module that processes recognized text, generated using the on-device speech recognition, image recognition, and/or optionally contextual data, to generate NLU data.

NLU data can include intent(s) that correspond to a sign language command and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the sign language command (and optionally the parameter(s) for the intent). This can include determining local and/or remote responses (e.g., answers) to the sign language command, interaction(s) with locally installed application(s) to perform based on the sign language command, command(s) to transmit to internet-of-things (IoT) device(s) (directly or via corresponding remote system(s)) based on the sign language command, and/or other resolution action(s) to perform based on the sign language command. The on-device fulfillment can then initiate local and/or remote performance/execution of the determined action(s) to resolve the sign language command.

In various implementations, remote image processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device signing processing, on-device NLU, on-device fulfillment, and/or on-device execution can be prioritized at least due to the latency reductions they provide when resolving a sign language command (due to no client-server roundtrip(s) being needed to resolve the sign language command). Further, on-device functionality can be the only functionality that is available in situations with no, or limited, network connectivity.

In some implementations, the computing device 202 can include one or more applications 234, which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202.

The assistant invocation engine 222 can process this data in order to determine whether or not to wait for a user to explicitly speak or sign an invocation phrase to invoke the automated assistant 204, or consider the data to be indicative of an intent by the user to invoke the automated assistant—in lieu of requiring the user to explicitly speak or sign the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken or signed invocation phrases from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include a presence detection engine 216 for determining whether a user is present near a device that provides access to the automated assistant 204. The presence of the user can be detected, with prior permission from the user, using sensor data from one or more sensors associated with the automated assistant 204. For example, object recognition can be performed on image data generated by one or more sensors to determine that a person is present at or near the computing device 202. In response, the presence detection engine 216 can communicate with a hands detection engine 218 to determine whether any hands of the user are within a field of view of a camera. Alternatively, in response to detecting the presence of the user, the presence detection engine 216 can initialize detection of a gaze of the user. When a gaze of the user is determined to be directed towards a camera, a graphical icon, and/or other object or feature, the automated assistant 204 can invoke the hands detection engine 218 for anticipating a sign language command from the user.

In some implementations, the hands detection engine 218 can determine whether one or both hands of the user are within a field of view of a camera. If they are, the hands detection engine 218 can provide, or bypass providing, positive feedback to encourage the user to keep their hands in the field of view of the camera if they are intending to provide a sign language command to the automated assistant 204. However, when one or both hands of the user are not detected by the hands detection engine 218, the hands detection engine 218 can cause an assistant interface 220 to provide negative feedback that indicates the hands of the user are not within a field of view of a camera. This negative feedback can be, for example, a graphical display output, a light blinking, a haptic output at a peripheral device, and/or any other feedback that can indicate that one or both hands of the user are not being detected.

When the user ultimately provides a sign language command that is detected and processed by the input processing engine 206, a gesture definition engine 226 can determine whether any particular sign language command is unfamiliar to the automated assistant 204. In some implementations, the input processing engine 206 can process image data and/or other data associated with a sign language input from a user, and determine whether a particular sign language gesture is unfamiliar to the automated assistant 204. When a particular sign language command is determined to be unfamiliar, the input processing engine 206 can communicate with the gesture definition engine 226. The gesture definition engine 226 can generate a request that can be rendered at an assistant interface 220 in furtherance of causing the user to provide a definition for an unfamiliar sign language gesture.

For example, certain interpretations for the particular sign language command may not satisfy a threshold confidence level, and, as a result, the gesture definition engine 226 can generate the request to have the user expressly translate the particular sign language command. When the user indicates the translation to the automated assistant 204 or other application 234, the gesture definition engine 226 can communicate with a training data engine 224 of the system 200. The training data engine 224 can generate training data that characterizes the translation and the particular sign language command. In this way, one or more models can be further trained using the training data, thereby allowing the automated assistant 204 to adapt to be responsive to unfamiliar sign language commands. This can eliminate many wasteful processes of assistant applications that may not similarly adapt under such circumstances. For example, an automated assistant that requires a user to spell out certain translations, as opposed to adapting to be responsive to shorter sign language commands, may waste computational resources and power on processing longer and more complicated sign language commands, which is obviated by using techniques described herein. Furthermore, by processing of unfamiliar sign language commands and/or other gesture-based commands, processing bandwidth can be wasted on rendering false positives or other inaccurate responses to unfamiliar sign language gestures and/or other gesture-based commands, which is also obviated by using techniques described herein.

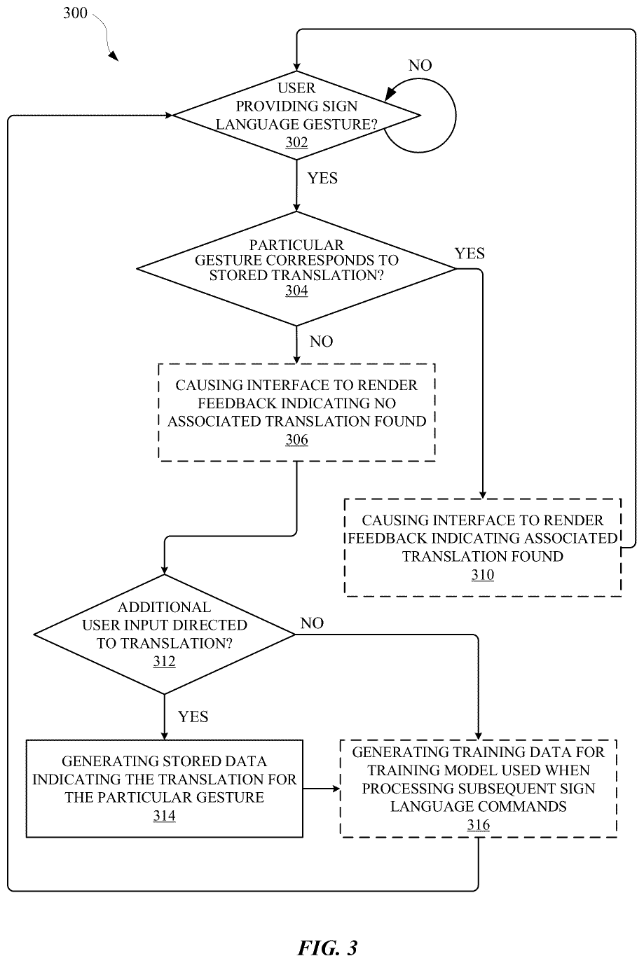

FIG. 3 illustrates a method 300 for operating an automated assistant that facilitates interactions through sign language commands and/or inaudible gestures, and adapts to be accurately responsive to inaudible gestures that refer to uncommon words or phrases. The method 300 can be performed by one or more applications, devices, and/or apparatus or module capable of interacting with an automated assistant. The method 300 can include an operation 302 of determining whether a user is providing a sign language gesture to an automated assistant application or other application. For example, the automated assistant can operate at a standalone display device with one or more sensors (e.g., a camera and/or other visual sensors) for receiving input data associated with the surroundings of the device. When input image data indicates that motion of a human is being detected, and/or that a user is directing their gaze at the display device, the automated assistant can cause the display device to provide feedback. For example, the feedback can include an inaudible output, such as a change to an operation of a light and/or display panel of the display device (e.g., turning on the display and/or light, blinking the light, and/or otherwise transitioning out of a low power mode). In some implementations, a display interface can render an interpretation of at least a portion of the sign language commands being received by the user. In some implementations, the interpretation of the sign language command can be rendered as natural language text (e.g., English words and alphabetic characters), American Sign Language (ASL) Gloss (e.g., natural language text with non-alphabetic symbols), depictions of hand language signs, and/or any other representation of an interpretation of a sign language command.

In some implementations, the automated assistant application can cause the input image data to be processed for determining whether the input image data characterizes a sign language gesture or other inaudible gesture. The input image data can be processed using one or more trained machine learning models and/or heuristic processes for determining whether the input image data corresponds to one or more sign language gestures. In some implementations, such recognition can be performed on-device without transmitting any input data to a server or other computing device, or, alternatively, can be offloaded to a server device for preserving resources of any local computing device.

When a sign language gesture is determined to be provided by the user, the method 300 can proceed from the operation 302 to an operation 304. The operation 304 can include determining whether a particular gesture performed by the user corresponds to a stored translation available to the automated assistant. In some implementations, determining whether the particular gesture corresponds to a stored translation can involve a variety of heuristic processes and/or employing one or more trained machine learning models. In some implementations, in determining a sign language command or portion thereof (if any), trained machine learning model(s) (e.g., neural network model(s)) that are stored locally on an assistant device are utilized by the client device to at least selectively process at least portions of sensor data from sensor component(s) of the client device (e.g., image frames from camera(s) of the client device, audio data from microphone(s) of the device, etc.). For example, the client device can process, for at least a duration (e.g., for at least a threshold duration and/or until presence is no longer detected) at least portion(s) of vision data utilizing locally stored machine learning model(s) in determining and classifying hand movements and/or other non-verbal gestures, performing facial recognition, and/or determining occurrence of other attribute(s).

In some versions of those implementations, one or more “upstream” models (e.g., object detection and classification model(s)) can be utilized to detect portions of vision data (e.g., image(s)) that are likely a face, hands, fingers, eye(s), mouth, etc.—and those portion(s) processed using a respective machine learning model. For example, the face and/or eye portion(s) of an image can be detected using the upstream model, and processed using a gaze machine learning model. Also, for example, finger and/or arm portion(s) of an image can be detected using the upstream model, and processed using a finger movement (optionally co-occurring with arm movement) machine learning model. As yet another example, human portion(s) of an image can be detected using the upstream model, and processed using a gesture machine learning model.

In some implementations, determining whether a particular gesture performed by the user corresponds to a stored translation available to the automated assistant at the operation 304 can include determining whether a score or metric indicates a degree of similarity between the particular sign language command and a stored translation. The score or metric can indicate latent distance(s) in a latent space between an embedding corresponding to the particular sign language command and other embedding(s) corresponding to one or more available translations. When a latent distance does not satisfy a threshold, the particular sign language command can be determined to not correspond to any currently stored translations available to the automated assistant. However, when the latent distance does satisfy the threshold for a particular translation, the particular sign language command can be determined to correspond to that particular translation.

When the particular gesture is determined to correspond to a stored translation, the method 300 can proceed from the operation 304 to an optional operation 310. The optional operation 310 can include causing an interface of a computing device to render feedback indicating that an associated translation has been found. For example, the particular sign language command can refer to a nickname or other name for a well-known historical figure (e.g., “Judge Learned Hand”), and the particular sign language command can be used by others to refer to this historical figure. As a result, the automated assistant may determine that there is a stored translation for the particular sign language command and optionally provide feedback in response to determining the translation for the particular sign language command. In some implementations, the feedback for the particular sign language command can be rendered as natural language text (e.g., English words and alphabetic characters), American Sign Language (ASL) Gloss (e.g., natural language text with non-alphabetic symbols), depictions of hand language signs, and/or any other representation of an interpretation of a sign language command. The automated assistant can optionally cause one or more actions to be performed based on the translation of at least the particular gesture.

When the particular sign language command is determined to not correspond to a stored translation available to the automated assistant, the method 300 can proceed from the operation 304 to an optional operation 306. The optional operation 306 can include causing an interface of a computing device to render feedback indicating no associated translation has been found for the particular sign language command. In some implementations, although the user may be aware of the translation and/other persons or devices may be aware of the translation, the feedback can be provided to indicate that the automated assistant does not currently have a stored translation that is readily accessible. In some implementations, this indication can be provided with a translation of any other sign language commands being provided by the user. For example, a placeholder can be rendered in place of whether the translation would otherwise appear if the particular sign language command had been determined. Alternatively, or additionally, the indication can be rendered as a visual indication (e.g., one or more colors and/or shapes rendered at a display interface), as haptic feedback, and/or as audible sound for users that can hear certain tones and/or frequencies. In some implementations, the indication can include a request for the user to provide an additional input for further defining the translation of the particular sign language command. For example, when the indication is a placeholder symbol and/or character, the placeholder can also solicit the user to provide additional input by referencing a function or command for supplementing an input (e.g., “Sign ‘more’ to fill in this space.”).

In some implementations, the method can include causing a display interface to render one or more selectable suggestions based on the particular sign language command. In some implementations, a selectable suggestion can be a graphical user interface (GUI) element that can be tapped via a touch input to a touch display interface and/or any other selectable feature of an application. Each selectable suggestion can include content that indicates an estimated translation for the particular sign language command. For example, a selectable suggestion that is rendered can include a suggested translation for the particular sign language command, and the content of the first selectable suggestion can be rendered as text, hand symbols, and/or ASL Gloss. In some implementations, the first selectable suggestion can include additional content that indicates a sign language command or other input that can be provided to select the first selectable suggestion. When the user is determined to have selected a selectable suggestion, the automated assistant can replace or append a word, phrase, letter, and/or symbol for an interpretation of the additional sign language command being provided by the user. This addition or replacement for the interpretation can then be processed with any initial interpretation of the sign language command in furtherance of performing a corrective action in response to the user providing the sign language command (e.g., responding to a corrected interpretation instead of any incorrect initial interpretation).

However, when the user does not select a suggestion, or a suggestion is not rendered, the user can provide an additional user input for providing a translation of the particular sign language command they previously provided. In response to receiving this additional user input, the automated assistant can cause one or more images of the sign language command to be captured and processed. In some implementations, the user can provide the additional user input as additional sign language commands that indicate a spelling of the translation (e.g., “J-U-D-G . . . ”, etc.) and/or user words to describe the translation (e.g., “I'm referring to a Federal Judge from . . . ”). In response to receiving the additional user input, the method 300 can proceed from the operation 312 to an operation 314. The automated assistant can optionally cause one or more actions to be performed based on the translation of at least the particular gesture. Otherwise, if no additional user input is received, the method 300 can proceed from the operation 312 to an optional operation 316.

The operation 314 can include generating stored data indicating the translation for the particular gesture. For example, characterizations of the particular sign language data can be stored in association with the translation as defined by the additional user input from the user. The characterization of the particular sign language data can be, but is not limited to, images of portions of the sign language command, text characterizing the sign language command, an embedding for the sign language command, contextual data associated with the sign language command, and/or any other information that can be utilized to characterize a sign language command. The translation data for the sign language command can include alphabetic characters, images, and/or any other information that can be stored for characterizing a translation of a sign language command.

The method 300 can proceed from the operation 314 to an optional operation 316, which can include generating training data for training one or more models used when processing subsequent sign language commands. In some implementations, the training data can include positive training data and/or negative training data associated with the particular sign language command and the translation. For example, when a user provides the translation as the additional user input at operation 312, the training data that is generated can be positive training data that correlates the particular sign language command with the translation. However, when the user does not provide the additional user input and/or the user indicates that a suggested translation for the particular sign language command is incorrect, negative training data can be generated. For example, the negative training data can indicate that the suggested translation is not an accurate translation for the particular sign language command, at least in the context of when the user had just provided the particular sign language command. One or more models can then be trained using this additional training data in furtherance of providing more accurate translations of sign language commands for a user. In some implementations, generative models can be utilized to generate additional training data that characterize hypothetical scenarios in which the particular sign language command may be expressed. As a result, even more training data can be generated for further training the models that are utilized when interpreting subsequent sign language inputs or other inaudible inputs from a user.

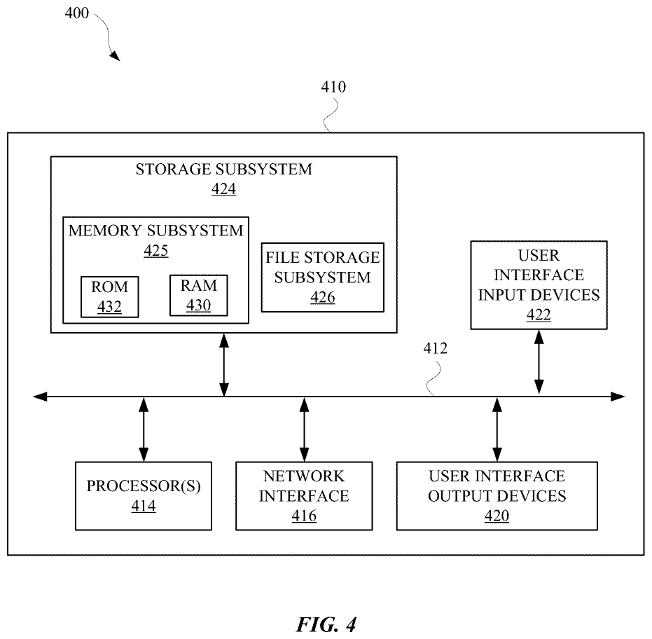

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided, and the method includes determining, by an automated assistant application, that a user is providing one or more sign language gestures. The automated assistant application is responsive to sign language gestures performed by one or both hands of the user, and a particular gesture of the one or more sign language gestures is unfamiliar to the automated assistant application. The method further includes determining, in response to receiving the one or more sign language gestures, that the particular gesture does not correspond to a stored translation associated with the automated assistant application. One or more models are utilized for the automated assistant application to determine whether the particular gesture does not correspond to the stored translation associated with the automated assistant application. The method further includes causing, by the automated assistant application, an interface of a computing device, or an additional computing device, to render an indication that the automated assistant lacks the stored translation for the particular gesture; and receiving an additional user input from the user in response to the interface rendering the indication. The additional user input characterizes the one or more sign language gestures. The method further includes causing, in response to receiving the additional user input, the automated assistant to perform one or more actions based on the additional user input that characterizes the one or more sign language gestures.

These and other implementations of technology disclosed herein can optionally include one or more of the following features.

In some implementations, the method can further include causing, in response to receiving the additional user input, additional training data to be generated for training the one or more models. The one or more models can be utilized for determining whether any subsequent sign language gestures include the one or more sign language gestures.

In some versions of those implementations, causing the additional training data to be generated for training the one or more models can include: accessing graphical data in furtherance of identifying positive training instances associated with the additional input. The graphical data can characterize the user or an additional user providing other sign language gestures that correspond to the one or more sign language gestures.

In some further versions of those implementations, the graphical data or the other graphical data can characterize a publicly available video that was uploaded to a public website or publicly accessible application.

In additional or alternative versions of those implementations, causing the additional training data to be generated for training the one or more models can include: accessing graphical data in furtherance of identifying negative training instances associated with the additional input. The other graphical data can characterize the user or an additional user providing other sign language gestures that do not correspond to the one or more sign language gestures.

In some implementations, receiving the additional user input from the user can include: processing one or more images or videos captured by a camera of the computing device, or the additional computing device. The one or more images can characterize additional sign language gestures performed by the user in response to the interface rendering the indication, and the one additional sign language gestures can fingerspell the particular gesture of the one or more sign language gestures that is unfamiliar to the automated assistant application.

In some implementations, receiving the additional user input from the user can include: processing one or more touch inputs captured by one or more interfaces of the computing device, or the additional computing device. The one or more touch inputs can characterize one or more symbols identified by the user in response to the interface rendering the indication.

In some versions of those implementations, the one or more symbols can indicate a written, natural language spelling for a proper noun or a concept.

In some implementations, the method can further include: causing, by the automated assistant application, the interface to render a translation of one or more other sign language gestures provided by the user before and/or after the user provided the one or more sign language gestures. The indication can be rendered with the translation of the one or more other sign language gestures.

In some versions of those implementations, the indication can include one or more other symbols that include a question mark or other natural language character.

In some implementations, the method can further include determining, based on contextual data associated with the user, that the user is estimated to specify a proper noun, a concept, or other type of word, during an interaction involving the automated assistant application and the one or more sign language gestures. Determining that the particular gesture does not correspond to the stored translation associated can be performed in response to determining that the user is estimated to specify the proper name, the concept, or the other type of word, during the interaction.

In some implementations, a method implemented by one or more processors is provided, and the method includes determining, by an automated assistant application, that a user is providing one or more sign language gestures. The automated assistant application is responsive to sign language gestures performed by one or both hands of the user, and a particular gesture, of the one or more sign language gestures, was previously defined by the user and for the automated assistant application. The method further includes determining that the one or more sign language gestures refer to a particular type of operation for the automated assistant application to initialize; and causing one or more models to be utilized to perform biased processing of input data that characterizes the one or more sign language commands. Processing of the input data is biased according to the particular type of operation for the automated assistant application to initialize. The method further includes determining, based on the biased processing, that the particular gesture corresponds to a stored identifier for the particular gesture that was previously defined by the user and for the automated assistant application; and causing, based on the stored translation and the input data, the automated assistant application to initialize performance of a particular operation that is responsive to the one or more sign language commands from the user.

These and other implementations of technology disclosed herein can optionally include one or more of the following features.

In some implementations, the particular type of operation can include one or more of: initiating a phone call, sending a message, purchasing an item, or controlling a smart home device.

In some versions of those implementations, causing the one or more models to be utilized to perform biased processing of the input data can include: causing a candidate translation of the particular gesture that relates to the particular type of operation to be weighted more than another candidate translation that does not relate to, or relates less to, the particular type of operation.

In some implementations, the method can further include: determining, based on the biased processing, that the particular gesture does not correspond to a different stored identifier for a different particular gesture that was also previously defined by the user and for the automated assistant application.

In some implementations, a method implemented by one or more processors is provided, and the method includes determining, by an automated assistant application, that a user is providing one or more sign language gestures. The automated assistant application is responsive to sign language gestures performed by one or both hands of the user, and a particular gesture of the one or more sign language gestures is unfamiliar to the automated assistant application. The method further includes determining, in response to receiving the one or more sign language gestures, that the particular gesture does not correspond to a stored translation associated with the automated assistant application. One or more models are utilized for the automated assistant application to determine whether the particular gesture does not correspond to the stored translation associated with the automated assistant application. The method further includes causing, by the automated assistant application, an interface of the computing device, or another computing device, to render a request for the user to provide a translation for the particular gesture for the automated assistant application; and receiving an additional user input from the user in response to the interface rendering the indication. The additional user input characterizes the particular gesture. The method further includes causing, in response to receiving the additional user input, one or more images to be generated for demonstrating how to perform the particular sign language gesture; and causing the one or more images to be accessible to a certain user that has interacted with an additional instance of the automated assistant application using other sign language gestures.

These and other implementations of technology disclosed herein can optionally include one or more of the following features.

In some implementations, the particular gesture can correspond to a label for a person, place, concept, or thing, and the one or more images can correspond to a video that is accessible via a separate application and/or a website.

In some implementations, the method can further include: determining whether to provide one or more other users with access to the one or more images. The one or more other users can include the certain user and determining to provide the certain user with access can include determining that the particular gesture is relevant to a prior interaction between the certain user and the automated assistant application.

In some versions of those implementations, the prior interaction can have involved the certain user communicating with the additional instance of automated assistant using other sign language commands that included the particular gesture.

In additional or alternative versions of those implementations, the prior interaction can have involved the certain user communicating with the additional instance of automated assistant using typed text to describe the particular gesture.

In some implementations, causing the one or more images to be generated can include employing one or more generative models to generate a video of an artificial intelligence (AI) generated entity demonstrating how to perform the particular gesture.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A method implemented by one or more processors, the method comprising:
determining, by an automated assistant application, that a user is providing one or more sign language gestures,
wherein the automated assistant application is responsive to sign language gestures performed by one or both hands of the user, and
wherein a particular gesture of the one or more sign language gestures is unfamiliar to the automated assistant application;
determining, in response to receiving the one or more sign language gestures, that the particular gesture does not correspond to a stored translation associated with the automated assistant application,
wherein one or more models are utilized for the automated assistant application to determine whether the particular gesture does not correspond to the stored translation associated with the automated assistant application;
causing, by the automated assistant application, an interface of a computing device, or an additional computing device, to render an indication that the automated assistant lacks the stored translation for the particular gesture;
receiving an additional user input from the user in response to the interface rendering the indication,
wherein the additional user input characterizes the one or more sign language gestures; and
causing, in response to receiving the additional user input, the automated assistant to perform one or more actions based on the additional user input that characterizes the one or more sign language gestures.

2. The method of claim 1, further comprising:
causing, in response to receiving the additional user input, additional training data to be generated for training the one or more models,
wherein the one or more models are utilized for determining whether any subsequent sign language gestures include the one or more sign language gestures.

3. The method of claim 2, wherein causing the additional training data to be generated for training the one or more models includes:
accessing graphical data in furtherance of identifying positive training instances associated with the additional input,
wherein the graphical data characterizes the user or an additional user providing other sign language gestures that correspond to the one or more sign language gestures.

4. The method of claim 3, wherein the graphical data or the other graphical data characterizes a publicly available video that was uploaded to a public website or publicly accessible application.

5. The method of claim 2, wherein causing the additional training data to be generated for training the one or more models includes:
accessing graphical data in furtherance of identifying negative training instances associated with the additional input,
wherein the other graphical data characterizes the user or an additional user providing other sign language gestures that do not correspond to the one or more sign language gestures.

6. The method of claim 1, wherein receiving the additional user input from the user includes:
processing one or more images or videos captured by a camera of the computing device, or the additional computing device,
wherein the one or more images characterize additional sign language gestures performed by the user in response to the interface rendering the indication, and
wherein the one additional sign language gestures fingerspell the particular gesture of the one or more sign language gestures that is unfamiliar to the automated assistant application.

7. The method of claim 1, wherein receiving the additional user input from the user includes:
processing one or more touch inputs captured by one or more interfaces of the computing device, or the additional computing device,
wherein the one or more touch inputs characterize one or more symbols identified by the user in response to the interface rendering the indication.

8. The method of claim 7, wherein the one or more symbols indicate a written, natural language spelling for a proper noun or a concept.

9. The method of claim 1, further comprising:
causing, by the automated assistant application, the interface to render a translation of one or more other sign language gestures provided by the user before and/or after the user provided the one or more sign language gestures,
wherein the indication is rendered with the translation of the one or more other sign language gestures.

10. The method of claim 9, wherein the indication includes one or more other symbols that include a question mark or other natural language character.

11. The method of claim 1, further comprising:
determining, based on contextual data associated with the user, that the user is estimated to specify a proper noun, a concept, or other type of word, during an interaction involving the automated assistant application and the one or more sign language gestures,
wherein determining that the particular gesture does not correspond to the stored translation associated is performed in response to determining that the user is estimated to specify the proper name, the concept, or the other type of word, during the interaction.

12. A method implemented by one or more processors, the method comprising:
determining, by an automated assistant application, that a user is providing one or more sign language gestures,
wherein the automated assistant application is responsive to sign language gestures performed by one or both hands of the user, and
wherein a particular gesture, of the one or more sign language gestures, was previously defined by the user and for the automated assistant application;
determining that the one or more sign language gestures refer to a particular type of operation for the automated assistant application to initialize;
causing one or more models to be utilized to perform biased processing of input data that characterizes the one or more sign language commands,
wherein processing of the input data is biased according to the particular type of operation for the automated assistant application to initialize;
determining, based on the biased processing, that the particular gesture corresponds to a stored identifier for the particular gesture that was previously defined by the user and for the automated assistant application; and
causing, based on the stored translation and the input data, the automated assistant application to initialize performance of a particular operation that is responsive to the one or more sign language commands from the user.

13. The method of claim 12, wherein the particular type of operation includes one or more of:
initiating a phone call, sending a message, purchasing an item, or controlling a smart home device.

14. The method of claim 13, wherein causing the one or more models to be utilized to perform biased processing of the input data includes:
causing a candidate translation of the particular gesture that relates to the particular type of operation to be weighted more than another candidate translation that does not relate to, or relates less to, the particular type of operation.

15. The method of claim 12, further comprising:
determining, based on the biased processing, that the particular gesture does not correspond to a different stored identifier for a different particular gesture that was also previously defined by the user and for the automated assistant application.

16. A method implemented by one or more processors, the method comprising:
determining, by an automated assistant application, that a user is providing one or more sign language gestures,
wherein the automated assistant application is responsive to sign language gestures performed by one or both hands of the user, and
wherein a particular gesture of the one or more sign language gestures is unfamiliar to the automated assistant application;
determining, in response to receiving the one or more sign language gestures, that the particular gesture does not correspond to a stored translation associated with the automated assistant application,
wherein one or more models are utilized for the automated assistant application to determine whether the particular gesture does not correspond to the stored translation associated with the automated assistant application;
causing, by the automated assistant application, an interface of the computing device, or another computing device, to render a request for the user to provide a translation for the particular gesture for the automated assistant application;
receiving an additional user input from the user in response to the interface rendering the indication,
wherein the additional user input characterizes the particular gesture;
causing, in response to receiving the additional user input, one or more images to be generated for demonstrating how to perform the particular sign language gesture; and
causing the one or more images to be accessible to a certain user that has interacted with an additional instance of the automated assistant application using other sign language gestures.

17. The method of claim 16, wherein the particular gesture corresponds to a label for a person, place, concept, or thing, and the one or more images correspond to a video that is accessible via a separate application and/or a website.

18. The method of claim 16, further comprising:
determining whether to provide one or more other users with access to the one or more images,
wherein the one or more other users include the certain user and determining to provide the certain user with access includes determining that the particular gesture is relevant to a prior interaction between the certain user and the automated assistant application.

19. The method of claim 18, wherein the prior interaction involved the certain user communicating with the additional instance of automated assistant using other sign language commands that included the particular gesture.

20. The method of claim 18, wherein the prior interaction involved the certain user communicating with the additional instance of automated assistant using typed text to describe the particular gesture.
